(19) United States
(12) Patent Application Publication
(10) Pub. No.: US 2023/0344710 A1
(43) Pub. Date: Oct. 26, 2023

(54) CENTRALIZED CONFIGURATION FOR A DISTRIBUTED SYSTEM

(71) Applicant: CDK GLOBAL, LLC, Hoffman Estates, IL (US)

(72) Inventors: Craig Gardner, Portland, OR (US); Yehor Mykhaylov, Arlington Heights, IL (US); Marc VonAhn, Portland, OR (US); Mark Helzer, Portland, OR (US); Tim Oppenlander, Portland, OR (US)

(21) Appl. No.: 17/660,285

(22) Filed: Apr. 22, 2022

(51) Int. Cl. H04L 41/082; H04L 41/084; H04L 41/0859; H04L 67/133

(52) U.S. Cl. CPC H04L 41/082; H04L 41/084; H04L 41/0859; H04L 67/133

(57) ABSTRACT

Embodiments herein relate to managing a distributed system with various local configurations using one or more centralized configurations. A central configuration system may store one or more centralized configurations for a set of applications. Updates to the centralized configurations may be transmitted to one or more of a plurality of local systems. The plurality of local systems may execute one or more of the set of applications. Each application may be associated with a local application configuration specific to a local system on which the application is executed. The local systems may determine whether the updates to the centralized configurations apply to the local application configuration for the one or more local applications stored on the memory, and update the local application configuration when the updates are applicable.

### TECHNICAL FIELD

The present disclosure relates generally to managing multiple configurations on a distributed system. More specifically, the present disclosure relates to methods, systems, and apparatuses for using one or more centralized configurations to manage multiple local configurations in a distributed system.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a distributed system that uses a centralized configuration to manage local application configurations in accordance with one embodiment.

FIG. 2 illustrates a data flow diagram for a local system using one or more centralized configurations in accordance with one embodiment.

FIG. 3 illustrates a method for managing application configurations in accordance with one embodiment.

FIG. 4 is a block diagram of a central configuration system in accordance with one embodiment.

FIG. 5 is a block diagram of a local dealer management system in accordance with one embodiment.

### DETAILED DESCRIPTION

Described herein are embodiments of systems, apparatuses, and methods for creating and managing a plurality of local application configurations using one or more centralized configurations. The plurality of local application configurations may be unique with overlapping portions. The centralized configurations may include data entries that are relevant to an individual local application configuration, a subset of local application configurations, and all local application configurations.

Applications may need to be tailored specifically for a certain implementation. For example, an application may be used by several customers. However, each customer may use a unique configuration for the application. The unique configuration may include using different data sets relevant to the customer, the location of the customer, the industry of the customer, or other factors. For instance, in some embodiments, the customers may include car dealerships. The car dealerships may have applications that use tax information. If the car dealerships are in different states they will need to use different tax information. Accordingly, each dealership may have a dealer management system with one or more applications with different local application configurations.

Due to the number of different local application configurations that possibly exists, manually updating each instance of a local application configuration may be time consuming and result in errors. One way to reduce the errors would be to completely rewrite the local application configuration whenever a change needs to be introduced. However, this may result in significant downtime of the dealer management system associated with the local application configuration for potentially minor updates. Additionally, manually updating each local application configuration becomes problematic as more dealer management systems are introduced featuring unique local application configurations.

Embodiments herein use a centralized configuration to update and onboard local systems efficiently. Embodiments herein use one or more common centralized configurations that may be altered and cause changes to occur to local application configurations in a local system. Some embodiments herein allow local application configurations to be updated without the need to completely rewrite the configuration storage to use the updates. In some embodiments, the applications listen to the changes and identify changes that are relevant to the particular instance of the application and local application configuration and automatically update the local application configuration. For example, a central configuration system may broadcast changes to a centralized configuration and each local dealer management system may determine if the update is applicable for their local application configurations and if the update is applicable apply the update. In other embodiments, the dealer management system may poll the central configuration system for updates.

Further, some local application configurations may be very customizable. The number of options may make onboarding a new customer or dealer difficult. Embodiments herein may reduce onboarding by having one place to configure each dealer management systems, and ensure that applications in a similar space are all configured the same. The centralized configuration can also be used as an application programming interface (API) for new applications to reduce development time by completely removing the need to build a configuration management interface and storage solution. The data from the centralized configuration can also be used to help sales teams by providing insight into potential gaps in a customer's processes.

In some embodiments herein, the dealer management systems belong to a car dealership. However, a similar system may be set up for other types of customers.

The phrases “coupled to,” “connected to,” and “in communication with” refer to any form of interaction between two or more components, including mechanical, electrical, magnetic, and electromagnetic interaction. Two components may be connected to each other, even though they are not in direct contact with each other, and even though there may be intermediary devices between the two components.

It will be readily understood that the components of the embodiments as generally described below and illustrated in the Figures herein could be arranged and designed in a wide variety of different configurations. For instance, the steps of a method do not necessarily need to be executed in any specific order, or even sequentially, nor do the steps need to be executed only once. Thus, the following more detailed description of various embodiments, as described below and represented in the Figures, is not intended to limit the scope of the disclosure but is merely representative of various embodiments. While the various aspects of the embodiments are presented in the drawings, the drawings are not necessarily drawn to scale unless specifically indicated.

Embodiments and implementations of systems and methods described herein may include various steps, which may be embodied in machine-executable instructions to be executed by a computer system. A computer system may include one or more general-purpose or special-purpose computers (or other electronic devices). The computer system may include hardware components that include specific logic for performing the steps or may include a combination of hardware, software, and/or firmware.

Embodiments may be provided as a computer program product including a computer-readable medium having stored thereon instructions that may be used to program a computer system or other electronic device to perform the processes described herein. The computer-readable medium may include, but is not limited to: hard drives, floppy disks, optical disks, CD-ROMs, DVD-ROMs, ROMs, RAMs, EPROMs, EEPROMs, magnetic or optical cards, solid-state memory devices, or other types of media/computer-readable media suitable for storing electronic instructions.

Computer systems and the computers in a computer system may be connected via a network. Suitable networks for configuration and/or use as described herein include one or more local area networks, wide area networks, metropolitan area networks, and/or Internet or Internet Protocol (IP) networks, such as the World Wide Web, a private Internet, a secure Internet, a value-added network, a virtual private network, an extranet, an intranet, or even stand-alone machines which communicate with other machines by physical transport of media. In particular, a suitable network may be formed from parts or entireties of two or more other networks, including networks using disparate hardware and network communication technologies.

One suitable network includes a server and several clients; other suitable networks may contain other combinations of servers, clients, and/or peer-to-peer nodes, and a given computer system may function both as a client and as a server. Each network includes at least two computers or computer systems, such as the server and/or clients. A computer system may include a workstation, laptop computer, mobile computer, server, mainframe, cluster, so-called “network computer” or “thin client,” tablet, smart phone, personal digital assistant or other hand-held computing device, “smart” consumer electronics device or appliance, medical device, or a combination thereof.

Suitable networks may include communications or networking software, such as the software available from Novell®, Microsoft®, and other vendors, and may operate using Transfer Control Protocol (TCP)/IP, SPX, IPX, and other protocols over twisted pair, coaxial, or optical fiber cables; telephone lines; radio waves; satellites; microwave relays; modulated AC power lines; physical media transfer; and/or other data transmission “wires” known to those of skill in the art. The network may encompass smaller networks and/or be connectable to other networks through a gateway or similar mechanism.

Each computer system includes one or more processors and/or memory; computer systems may also include various input devices and/or output devices. The processor may include a general-purpose device, such as an Intel®, AMD®, or other “off-the-shelf” microprocessor. The processor may include a special-purpose processing device, such as an ASIC, SoC, SiP, FPGA, PAL, PLA, FPLA, PLD, or other customized or programmable device. The memory may include static RAM, dynamic RAM, flash memory, one or more flip-flops, ROMs, CD-ROMs, disks, tapes, or magnetic, optical, or other computer storage medium. The input device(s) may include a keyboard, mouse, touch screen, light pen, tablet, microphone, sensor, or other hardware with accompanying firmware and/or software. The output device(s) may include a monitor or other display, printer, speech or text synthesizer, switch, signal line, or other hardware with accompanying firmware and/or software.

The computer systems may be capable of using a floppy drive, tape drive, optical drive, magneto-optical drive, or other means to read a storage medium. A suitable storage medium includes a magnetic, optical, or other computer-readable storage device having a specific physical configuration. Suitable storage devices include floppy disks, hard drives, tapes, CD-ROMs, DVDs, PROMs, RAMs, and flash memory and other computer system storage devices. The physical configuration represents data and instructions which cause the computer system to operate in a specific and predefined manner as described herein.

Suitable software to assist in implementing the invention is readily provided by those of skill in the pertinent art(s) using the teachings presented here and programming languages and tools such as Modern Fortran, Java, Pascal, C++, C, PHP, .Net, database languages, APIs, SDKs, and assembly, firmware, microcode, and/or other languages and tools. Suitable signal formats may be embodied in analog or digital form, with or without error detection and/or correction bits, packet headers, network addresses in a specific format, and/or other supporting data readily provided by those of skill in the pertinent art(s).

Aspects of certain embodiments may be implemented as software modules or components. As used herein, a software module or component may include any type of computer instruction or computer executable code located within or on a computer-readable storage medium. A software module may, for instance, comprise one or more physical or logical blocks of computer instructions, which may be organized as a routine, program, object, component, data structure, etc., that performs one or more tasks or implements particular abstract data types. A particular software module may comprise disparate instructions stored in different locations of a computer-readable storage medium, which together implement the described functionality of the module. Indeed, a module may comprise a single instruction or many instructions, and may be distributed over several different code segments, among different programs, and across several computer-readable storage media.

Some embodiments may be practiced in a distributed computing environment where tasks are performed by a remote processing device linked through a communications network. In a distributed computing environment, software modules may be located in local and/or remote computer-readable storage media. In addition, data being tied or rendered together in a database record may be resident in the same computer-readable storage medium, or across several computer-readable storage media, and may be linked together in fields of a record in a database across a network. According to one embodiment, a database management system (DBMS) allows users to interact with one or more databases and provides access to the data contained in the databases.

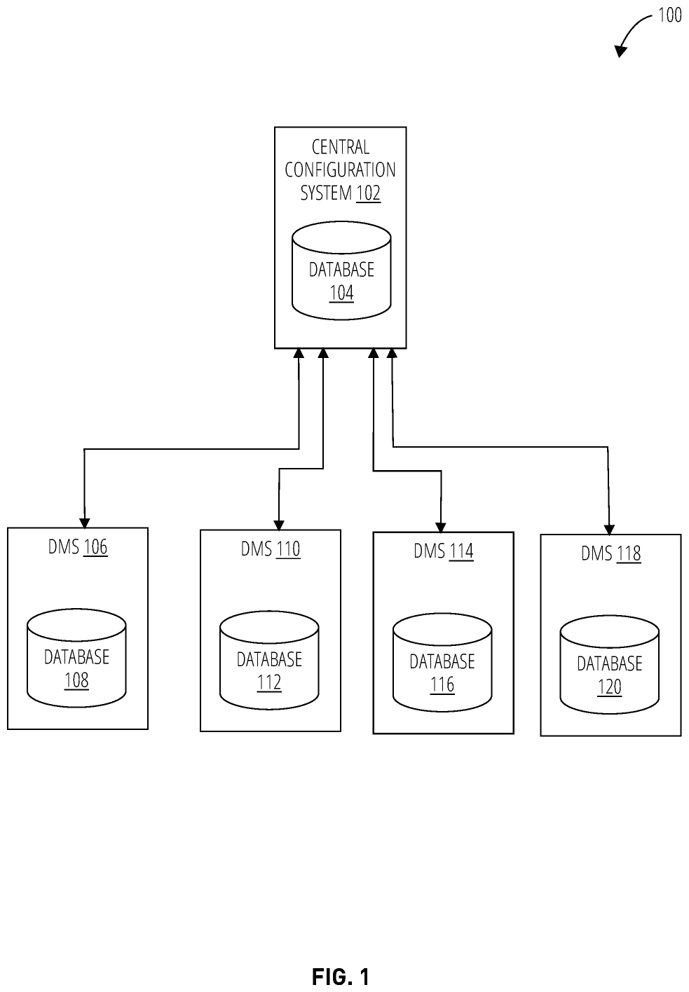

FIG. 1 illustrates a distributed system 100 that uses a centralized configuration to manage local application configurations. The distributed system 100 includes a central configuration system 102 in communication with multiple dealer management systems (e.g., a first DMS 106, second DMS 110, third DMS 114, fourth DMS 118). While the illustrated distributed system 100 only shows four dealer management systems, an implementation of the distributed system 100 may include more than a thousand dealer management systems.

The dealer management systems may be systems for customers (e.g., a dealerships) to operate one or more applications used for their business. Each dealer management system may include a database (e.g., database 108, database 112, database 116, database 120). The database may store one or more local applications to be executed by the dealer management system and corresponding local application configurations. The applications may be configured uniquely for a particular client, location, or type of business, and/or based on additional factors. The local applications may be configured using the local application configurations.

The applications may perform functions for operating a dealership. For example, the applications may include a human resources application, a sales application, an inventory application, and other dealership-related applications. The applications on one dealer management system may function similar to an application on another dealer management system. However, the application may be tailored specifically for each client. For instance, a local application configuration may be applied to create particular instances of the applications based on the customers' desires.

While this customizability provides a customer with a product tailored to their application, it becomes difficult to maintain as the number of dealership management systems, applications, and unique configurations grows. The distributed system 100 can use one or more centralized configurations on a database 104 of the central configuration system 102 to more effectively manage local application configurations.

For instance, some of the configuration choices may overlap between different dealer management systems. For instance, dealers in the same state may have applications that use a same tax table. Some common configuration elements may be present on all or a portion of the dealer management systems (e.g., a state table and a province table). Some common configuration elements between dealer management systems may be a result of having a same or similar dealer type, dealer owner, dealer location, and/or dealer inventory. Rather than editing each individual local application configuration, a centralized configuration may be edited, and the change to the centralized configuration may then be automatically applied to any relevant local application configuration. The distributed system 100 can make sure that applications in a similar space are all configured the same.

The central configuration system 102 may include the database 104. The database 104 may store one or more centralized configurations. The centralized configurations may apply to one or more applications. The centralized configurations may comprise configuration elements (e.g., values, data entries, tables, documents, files, items, etc.) for all of the different configurations of local applications on the dealer management systems. In other words, the centralized application configurations may contain the information from all of the local application configurations, and the local application configurations may reflect a subset of the configuration elements of the centralized application configurations.

Additionally, the centralized configurations can include a single instance of a configuration element common (e.g., a parish tax table) to two or more local application configurations rather than store configuration redundant elements for each local application configuration separately. The single instance of the configuration element may be edited by a database engineer, and then the distributed system 100 may cause the changes to be made to each relevant local application configuration. Thus, the centralized configurations allow a database manager to make updates to configuration information at a central location that is then reflected throughout the distributed system 100 on the local application configurations of the dealer management systems. This can prevent applications from having out-of-sync configurations while still allowing the applications to be customized to a customer. In some embodiments, the updates may be published as a broadcast to all dealer management systems. The dealer management systems may then determine if the update is relevant. In some embodiments, the dealer management systems may periodically poll the central configuration system 102 to determine if there are updates for any configuration elements of the local application configurations.

The centralized configurations may also be used to help improve an onboarding process for new dealer management systems by having one place to configure the dealership's system. For example, the centralized configurations can be used as an API for setting up new local application configurations. In some embodiments, an installer may use a program that makes calls for desired configuration elements using the API for a new local application configuration. For instance, the API may be used to request specific configurations or settings for configurations. In some embodiments, a graphical user interface (GUI) may assist an installer in configuring an application using the API. For example, the GUI may present the installer with text fields, drop down lists, radio buttons, or other GUI input elements to receive user inputs indicating a desired configuration. An installation software may then translate the GUI inputs into proper API calls to retrieve the requested data for the desired configuration. In some embodiments, the configuration of one application may be based on the local application configuration of a second application on the same dealer management system.

In some embodiments, the updates may be published as a broadcast to all dealer management systems. The dealer management systems may then determine if the update is relevant. In some embodiments, the dealer management systems may periodically poll the central configuration system 102 to determine if there are updates for any configuration elements of the local application configurations.

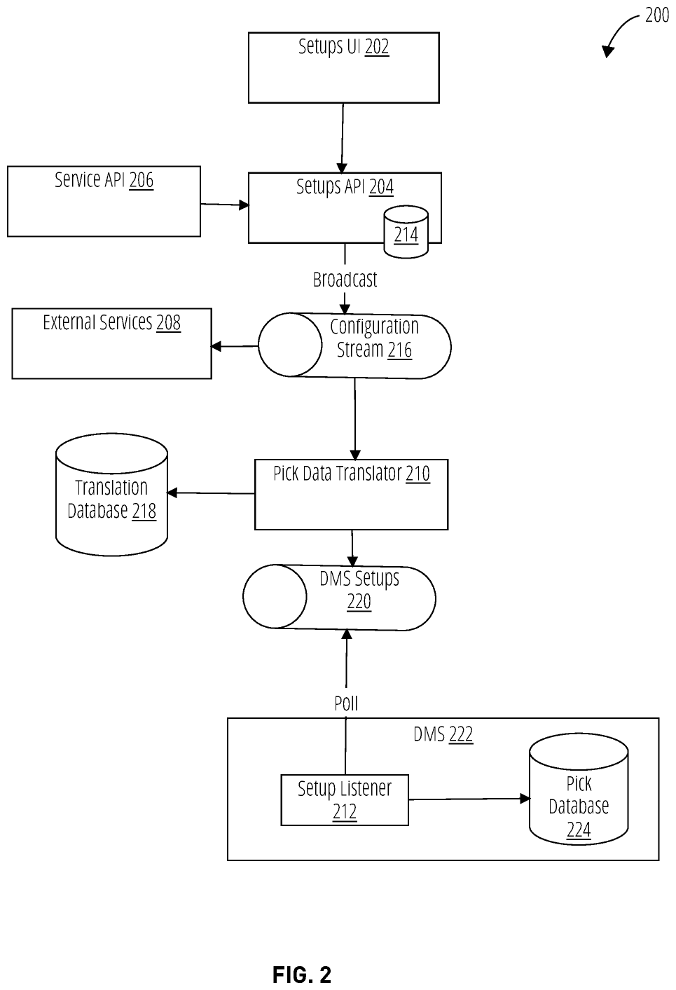

FIG. 2 illustrates a data flow diagram 200 for a local system using one or more centralized configurations according to one embodiment. The embodiment illustrated in FIG. 2 may be used by a local system, such as the distributed system 100, to set up and manage local application configurations using one or more centralized configurations.

Setups user interface (UI) 202 provides an input mechanism for a user to create or edit a centralized configuration. The centralized configurations may be stored as configuration data on a database 214. A query using a service API 206 may request, via setups API 204, a retrieval of configuration data from the database 214.

Any new configuration data or changes to the centralized configurations may be broadcast by the setups API 204. The broadcast may be sent over a configuration stream 216. External services 208 and dealer management systems (e.g., DMS 222) may access the configuration stream 216 to receive the configuration data.

In the illustrated embodiment, the database 214 storing the centralized configurations is a different database type than a database 224 of the DMS 222. For instance, the database 214 may be a modern microservice architecture and the database 224 of the DMS 222 may be a pick environment. In such a case where the databases are incongruent, a pick data translator 210 may be used to convert the broadcast configuration data from one database type to another using a translation database 218. The translated broadcast may be sent to DMS setups 220 stream that may be polled by the DMS 222. A setup listener 212 may poll the DMS setups 220 to receive the translated broadcast. Any new local application configurations may be stored in the database 224, and any changes to preexisting application configurations from the broadcast may be updated in the database 224. In some embodiments, the DMS 222 may query the service API 206 or setups API 204 directly to get the configuration data.

The setups API 204 may broadcast the updates to the configuration data via a messaging system (e.g., Kafka). The updates may include a variety of changes. For example, the updates may indicate a tax rate change for Indiana and that dealership number 123 has a new employee. The DMS 222 and other dealer management systems listen to the messages and determine whether the update is applicable to their system. If the updates are not applicable, the DMS 222 may ignore the updates; otherwise the DMS 222 implements the updates.

The DMS 222 may determine the applicability of the update based on what category the update covers. For example, the DMS 222 may determine if an update is applicable based on a location or region (e.g., Tennessee, Midwest, Canada, etc.), a dealer identification number, a configuration name (e.g., tax rate could indicate an update to the tax configuration), or enterprise identification. The DMS 222 may use such categories to filter the applicable messages and only implement changes in applicable updates.

The categories of the updates may be indicated as part of the message. For example, the category may be part of the payload. For instance, the update category may be in an envelope or header of the payload. In some embodiments, the category of the update may be used as a topic for a messaging service such as Kafka. For instance, the central configuration system may post the update to a topic that is all about tax rates or more specifically tax rates in Alabama. Dividing topics by category may reduce the amount of data transmitted between the central configuration system and the DMS 222 because if the DMS 222 is not applicable, the DMS 222 may not need to download the update.

There may be a large number of different settings for each category that may be updated for a configuration. Examples of broad categories and settings may include service, sales, finance and insurance, accounting, parts (e.g., purchase orders inventory, etc.), business objects, online sales calculation engine (this may be used to send quotes correctly), credit compliance, available lenders, document storage, data archiving, original equipment manufacturer communication settings, default printers, network configuration, phone configuration, etc.

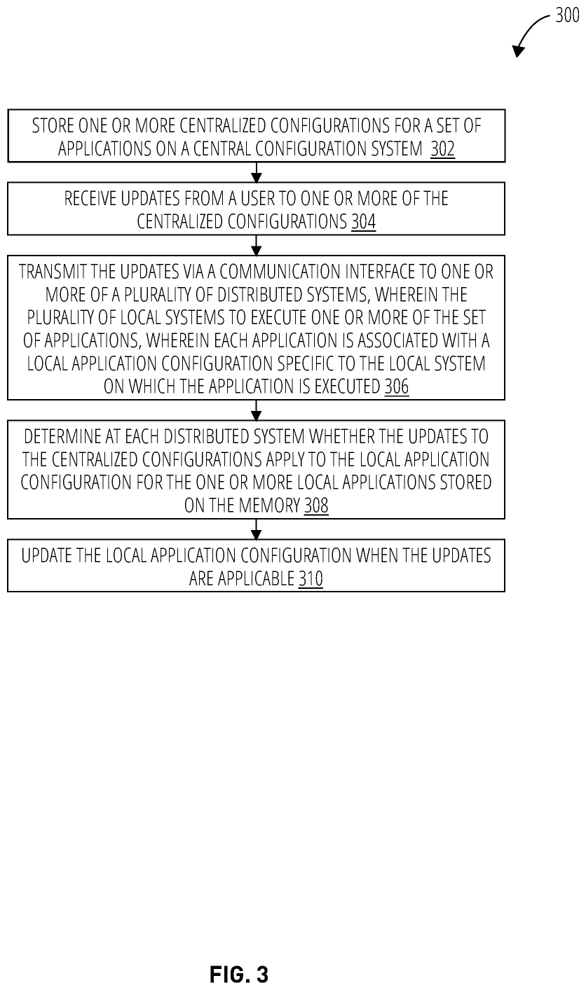

FIG. 3 illustrates a flow chart of a method 300 for managing application configurations for a distributed system using one or more centralized configurations. The method may be performed by a distributed system such as the distributed system 100. In some embodiments, the distributed systems may include dealer management systems.

As shown, a system using the method 300 may store 302, at a central configuration system, one or more centralized configurations for a set of applications on a central configuration system. In some embodiments, the centralized configurations contain common configuration files that correspond to multiple local configurations. A system using the method 300 may further receive 304 updates from a user to one or more of the centralized configurations at the central configuration system.

The central configuration system may further transmit 306 the updates via a communication interface to one or more of a plurality of local systems. The plurality of local systems may be configured to execute one or more of the set of applications. Each application may be associated with a local application configuration specific to a local system on which the application is executed. In some embodiments, a first local application configuration stored on a first local system includes a subset of configurations that match a second local application configuration stored on a second local system. In some embodiments, a processor of the local systems is configured to poll the central configuration system for the updates. In some embodiments, the processor circuitry of the central configuration system is further to publish the updates via the communication interface to all of the plurality of local systems.

The local systems may further determine 308 whether the updates to the centralized configurations apply to the local application configuration for the one or more local applications stored on the memory. For example, the updates may comprise a topic, and the local system may identify the topic and determine whether the topic corresponds to the local application configuration. As another example, updates may comprise a payload envelope or payload header that is used by the processor of the local systems to determine whether the updates apply to the local application configuration. The local systems may further update 310 the local application configuration when the updates are applicable. In some embodiments, the centralized configurations may be used as an API for setting up new local application configurations.

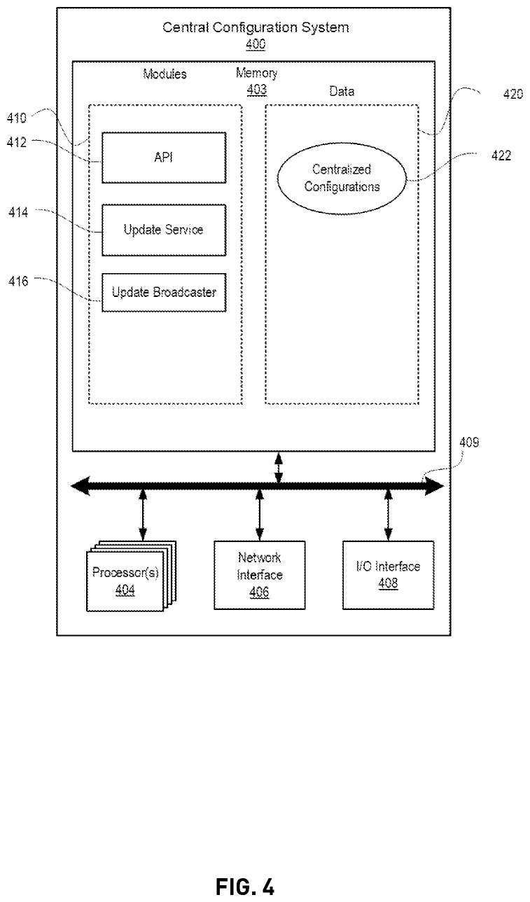

FIG. 4 is a block diagram of a central configuration system 400 according to one embodiment. The central configuration system 400 may perform the methods and use the techniques described with reference to the other figures in the specification. The central configuration system 400 can include a memory 403, one or more processors 404, a network interface 406, an input/output interface 408, and a system bus 409.

The one or more processors 404 may include one or more general-purpose devices, such as an Intel®, AMD®, or other standard microprocessor. The one or more processors 404 may include a special-purpose processing device, such as ASIC, SoC, SiP, FPGA, PAL, PLA, FPLA, PLD, or other customized or programmable device. The one or more processors 404 can perform distributed (e.g., parallel) processing to execute or otherwise implement functionalities of the presently disclosed embodiments. The one or more processors 404 may run a standard operating system and perform standard operating system functions. It is recognized that any standard operating systems may be used, such as, for example, Microsoft® Windows®, Apple® MacOS®, Disk Operating System (DOS), UNIX, IRJX, Solaris, SunOS, FreeBSD, Linux®, ffiM® OS/2® operating systems, and so forth.

The memory 403 may include static RAM, dynamic RAM, flash memory, one or more flip-flops, ROM, CD-ROM, DVD, disk, tape, or magnetic, optical, or other computer storage medium. The memory 403 may include a plurality of program modules 410 and program data 420. The memory 403 may be local to the central configuration system 400, as shown, or may be distributed and/or remote relative to the central configuration system 400.

Data generated or used by the central configuration system 400, such as by the program modules 410 or other modules, may be stored on the memory 403, for example, as stored program data 420. The data 420 may be organized as one or more databases. The data 420 may include centralized configurations 422. The centralized configurations 422 may comprise one or more configurations. The centralized configurations 422 may include settings and data for one or more applications. The centralized configurations 422 may comprise configuration elements (e.g., values, data entries, tables, documents, files, items, etc.) for the different configurations of local applications on the dealer management systems.

The program modules 410 may run multiple operations concurrently or in parallel by or on the one or more processors 404. In some embodiments, portions of the disclosed modules, components, and/or facilities are embodied as executable instructions embodied in hardware or firmware, or stored on a non-transitory, machine-readable storage medium. The executable instructions may comprise a computer program code that, when executed by a processor and/or computing device, causes a computing system to implement certain processing steps, procedures, and/or operations, as disclosed herein. The modules, components, and/or facilities disclosed herein may be implemented and/or embodied as a driver, a library, an interface, an API, FPGA configuration data, firmware (e.g., stored on an EEPROM), and/or the like. In some embodiments, portions of the modules, components, and/or facilities disclosed herein are embodied as machine components, such as general and/or application-specific devices, including, but not limited to: circuits, integrated circuits, processing components, interface components, hardware controller(s), storage controller(s), programmable hardware, FPGAs, ASICs, and/or the like. Accordingly, the modules disclosed herein may be referred to as controllers, layers, services, engines, facilities, drivers, circuits, subsystems, and/or the like.

The program modules 410 may comprise an API 412, an update service 414, and an update broadcaster 416. The API 412 may handle requests for the data 420 to be sent to dealer management systems and third party services. The update service 414 may allow a user to update the centralized configurations 422. The update broadcaster 416 may transmit updates via the network interface 406.

The input/output interface 408 may facilitate user interaction with one or more input devices and/or one or more output devices. The input device(s) may include a keyboard, mouse, touchscreen, light pen, tablet, microphone, sensor, or other hardware with accompanying firmware and/or software. The output device(s) may include a monitor or other display, printer, speech or text synthesizer, switch, signal line, or other hardware with accompanying firmware and/or software. For example, in one embodiment, the input/output interface 408 comprises a display to provide a graphical user interface (GUI) illustrating potential ablation perimeters. The input/output interface 408 can receive user input data. In some embodiments, the input/output interface 408 is a touchscreen, and the size input is received via the touchscreen. In some embodiments, the input/output interface 408 can superimpose the target ablation perimeters on an image of tissue.

The network interface 406 may facilitate communication with other computing devices and/or networks and/or other computing and/or communications networks. The network interface 406 may be equipped with conventional network connectivity, such as, for example, Ethernet (IEEE 1102.3), Token Ring (IEEE 1102.5), Fiber Distributed Datalink Interface (FDDI), or Asynchronous Transfer Mode (ATM). Further, the network interface 406 may be configured to support a variety of network protocols such as, for example, Internet Protocol (IP), Transfer Control Protocol (TCP), Network File System over UDP/TCP, Server Message Block (SMB), Microsoft® Common Internet File System (CIFS), Hypertext Transfer Protocols (HTTP), Direct Access File System (DAFS), File Transfer Protocol (FTP), Real-Time Publish Subscribe (RTPS), Open Systems Interconnection (OSI) protocols, Simple Mail Transfer Protocol (SMTP), Secure Shell (SSH), Secure Socket Layer (SSL), and so forth.

The system bus 409 may facilitate communication and/or interaction between the other components of the central configuration system 400, including the one or more processors 404, the memory 403, the input/output interface 408, and the network interface 406.

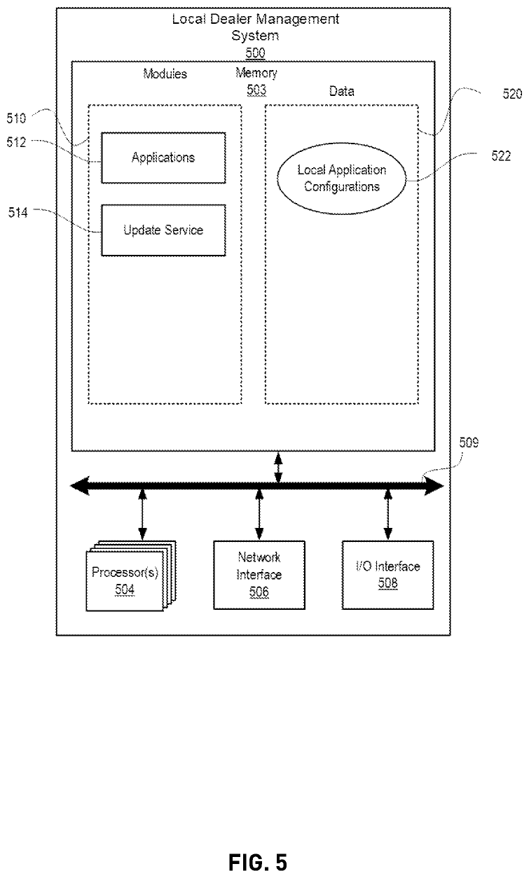

FIG. 5 is a block diagram of a local dealer management system 500 according to one embodiment. The local dealer management system 500 is also referred to herein as a local system, a dealer management system, and a DMS. The local dealer management system 500 can include a memory 503, one or more processors 504, a network interface 506, an input/output interface 508, and a system bus 509.

The one or more processors 504 may include one or more general-purpose devices, such as an Intel®, AMD®, or other standard microprocessor. The one or more processors 504 may include a special-purpose processing device, such as ASIC, SoC, SiP, FPGA, PAL, PLA, FPLA, PLD, or other customized or programmable device. The one or more processors 504 can perform distributed (e.g., parallel) processing to execute or otherwise implement functionalities of the presently disclosed embodiments. The one or more processors 504 may run a standard operating system and perform standard operating system functions. It is recognized that any standard operating systems may be used, such as, for example, Microsoft® Windows®, Apple® MacOS®, Disk Operating System (DOS), UNIX, IRJX, Solaris, SunOS, FreeBSD, Linux®, ffiM® OS/2® operating systems, and so forth.

The memory 503 may include static RAM, dynamic RAM, flash memory, one or more flip-flops, ROM, CD-ROM, DVD, disk, tape, or magnetic, optical, or other computer storage medium. The memory 503 may include a plurality of program modules 510 and program data 520. The memory 503 may be local to the local dealer management system 500, as shown, or may be distributed and/or remote relative to the local dealer management system 500.

Data generated or used by the local dealer management system 500, such as by the program modules 510 or other modules, may be stored on the memory 503, for example, as the stored program data 520. The data 520 may be organized as one or more databases. The data 520 may include local application configurations 522. The local application configurations 522 may comprise settings and data for one or more applications 512 that may be customized for each DMS. The local application configurations 522 may comprise configuration elements (e.g., values, data entries, tables, documents, files, items, etc.) for the one or more applications 512.

The program modules 510 may run multiple operations concurrently or in parallel by or on the one or more processors 504. In some embodiments, portions of the disclosed modules, components, and/or facilities are embodied as executable instructions embodied in hardware or firmware, or stored on a non-transitory, machine-readable storage medium. The executable instructions may comprise computer program code that, when executed by a processor and/or computing device, causes a computing system to implement certain processing steps, procedures, and/or operations, as disclosed herein. The modules, components, and/or facilities disclosed herein may be implemented and/or embodied as a driver, a library, an interface, an API, FPGA configuration data, firmware (e.g., stored on an EEPROM), and/or the like. In some embodiments, portions of the modules, components, and/or facilities disclosed herein are embodied as machine components, such as general and/or application-specific devices, including, but not limited to: circuits, integrated circuits, processing components, interface components, hardware controller(s), storage controller(s), programmable hardware, FPGAs, ASICs, and/or the like. Accordingly, the modules disclosed herein may be referred to as controllers, layers, services, engines, facilities, drivers, circuits, subsystems, and/or the like.

The program modules 510 may comprise the one or more applications 512 and an update service 514. The update service 514 may receive updates from a central configuration system, determine whether the updates apply to the local application configurations 522, and update the local application configurations 522 when the updates are applicable.

The input/output interface 508 may facilitate user interaction with one or more input devices and/or one or more output devices. The input device(s) may include a keyboard, mouse, touchscreen, light pen, tablet, microphone, sensor, or other hardware with accompanying firmware and/or software. The output device(s) may include a monitor or other display, printer, speech or text synthesizer, switch, signal line, or other hardware with accompanying firmware and/or software. For example, in one embodiment, the input/output interface 508 comprises a display to provide a graphical user interface (GUI) illustrating potential ablation perimeters. The input/output interface 508 can receive user input data. In some embodiments, the input/output interface 508 is a touchscreen, and the size input is received via the touchscreen. In some embodiments, the input/output interface 508 can superimpose the target ablation perimeters on an image of tissue.

The network interface 506 may facilitate communication with other computing devices and/or networks and/or other computing and/or communications networks. The network interface 506 may be equipped with conventional network connectivity, such as, for example, Ethernet (IEEE 1102.3), Token Ring (IEEE 1102.5), Fiber Distributed Datalink Interface (FDDI), or Asynchronous Transfer Mode (ATM). Further, the network interface 506 may be configured to support a variety of network protocols such as, for example, Internet Protocol (IP), Transfer Control Protocol (TCP), Network File System over UDP/TCP, Server Message Block (SMB), Microsoft® Common Internet File System (CIFS), Hypertext Transfer Protocols (HTTP), Direct Access File System (DAFS), File Transfer Protocol (FTP), Real-Time Publish Subscribe (RTPS), Open Systems Interconnection (OSI) protocols, Simple Mail Transfer Protocol (SMTP), Secure Shell (SSH), Secure Socket Layer (SSL), and so forth.

The system bus 509 may facilitate communication and/or interaction between the other components of the local dealer management system 500, including the one or more processors 504, the memory 503, the input/output interface 508, and the network interface 506.

Any methods disclosed herein comprise one or more steps or actions for performing the described method. The method steps and/or actions may be interchanged with one another. In other words, unless a specific order of steps or actions is required for proper operation of the embodiment, the order and/or use of specific steps and/or actions may be modified.

While specific embodiments have been illustrated and described, it is to be understood that the disclosure provided is not limited to the precise configuration and components disclosed. Various modifications, changes, and variations apparent to those of skill in the art having the benefit of this disclosure may be made in the arrangement, operation, and details of the methods and systems disclosed, with the aid of the present disclosure.

Without further elaboration, it is believed that one skilled in the art can use the preceding description to utilize the present disclosure to its fullest extent. The examples and embodiments disclosed herein are to be construed as merely illustrative and exemplary and not a limitation of the scope of the present disclosure in any way. It will be apparent to those having skill, having the benefit of this disclosure, in the art that changes may be made to the details of the above-described embodiments without departing from the underlying principles of the disclosure herein.

1. A configuration management system comprising:
a central configuration system comprising:
a database to store one or more centralized configurations for a set of applications;
a communication interface; and
processor circuitry to:
receive updates to one or more of the centralized configurations, and
transmit the updates via the communication interface to one or more of a plurality of local systems separate from the central configuration system, wherein the updates comprise a change to one or more categories of the one or more centralized configurations; and
the plurality of local systems in communication with the central configuration system, the plurality of local systems to execute one or more of the set of applications, wherein each application is associated with a local application configuration specific to a local system on which the application is executed, each of the plurality of local systems comprising:
memory to store one or more local applications and a corresponding one or more local application configurations, and
a processor to:
receive the updates published by the central configuration system;
based at least on a location, a region, or a combination thereof, of the local system, determine whether the updates to the centralized configurations apply to the local application configuration for the one or more local applications stored on the memory; and
update local application configuration data of the local application configuration when the updates are applicable.

2. The configuration management system of claim 1, wherein a first local application configuration stored on a first local system includes a subset of configurations that match a second local application configuration stored on a second local system.

3. The configuration management system of claim 1, wherein the updates comprise a topic, and wherein the processor is further to identify the topic and determine whether the topic corresponds to the local application configuration.

4. The configuration management system of claim 1, wherein the updates comprise a payload envelope or payload header that is used by the processor of the local systems to determine whether the updates apply to the local application configuration.

5. The configuration management system of claim 1, wherein the centralized configurations contain common configuration files that correspond to multiple local configurations.

6. The configuration management system of claim 1, wherein the local systems comprise dealer management systems.

7. The configuration management system of claim 1, wherein the centralized configurations are used as an application programming interface (API) for setting up new local application configurations.

8. The configuration management system of claim 1, wherein the processor of the local systems is further configured to poll the central configuration system for the updates.

9. The configuration management system of claim 1, wherein the processor circuitry of the central configuration system is further to publish the updates via the communication interface to all of the plurality of local systems.

10. A method for managing application configurations, the method comprising:
storing one or more centralized configurations for a set of applications on a central configuration system;
receiving updates, at the central configuration system, from a user to one or more of the centralized configurations;
transmitting the updates via a communication interface from the central configuration system to one or more of a plurality of local systems separate from the central configuration system,
wherein the plurality of local systems are configured to execute one or more local applications,
wherein each local application is associated with a local application configuration specific to a local system on which the application is executed, and
wherein the updates comprise a change to one or more categories of the one or more centralized configurations;
determining at each local system, based at least on a location, a region, or a combination thereof, of the local system, whether the updates to the centralized configurations apply to the local application configuration for the one or more local applications; and
updating local application configuration data of the local application configuration when the updates are applicable.

11. The method of claim 10, wherein a first local application configuration stored on a first local system includes a subset of configurations that match a second local application configuration stored on a second local system.

12. The method of claim 10, wherein the updates comprise a topic, and wherein the local systems identify the topic and determine whether the topic corresponds to the local application configuration.

13. The method of claim 10, wherein the updates comprise a payload envelope or payload header that is used by the local systems to determine whether the updates apply to the local application configuration.

14. The method of claim 10, wherein the centralized configurations contain common configuration files that correspond to multiple local configurations.

15. The method of claim 10, wherein the local systems comprise dealer management systems.

16. The method of claim 10, wherein the centralized configurations are used as an application programming interface (API) for setting up new local application configurations.

17. The method of claim 10, wherein the plurality of local systems is further configured to poll the central configuration system for the updates.

18. The method of claim 10, wherein the central configuration system is further to publish the updates via the communication interface to all of the plurality of local systems.

19. A non-transitory computer-readable storage medium, the computer-readable storage medium including instructions that, when executed by a computer, cause the computer to:
store one or more centralized configurations for a set of applications on a central configuration system;
receive updates, at the central configuration system, from a user to one or more of the centralized configurations;
transmit the updates via a communication interface from the central configuration system to one or more of a plurality of local systems separate from the central configuration system, wherein the plurality of local systems is configured to execute one or more local applications, wherein each application is associated with a local application configuration specific to a local system on which the application is executed, and wherein the updates comprise a change to one or more categories of the one or more centralized configurations;
determine at each local system, based at least on a location, a region, or a combination thereof, of the local system, whether the updates to the centralized configurations apply to the local application configuration for the one or more local applications; and
update local application configuration data of the local application configuration when the updates are applicable.

20. The computer-readable storage medium of claim 19, wherein the centralized configurations are used as an application program interface (API) for setting up new local application configurations.
